(19) United States
(12) Patent Application Publication
(10) Pub. No.: US 2007/0285788 A1
(43) Pub. Date: Dec. 13, 2007

(54) Anti-Glare Device and Method for Making the Same

(75) Inventors: Cheng-Hsin Yeh, Taoyuan (TW); Chiu-Fang Huang, Taoyuan (TW); Wen-Yi Lin, Taoyuan (TW)

Correspondence Address: WHYTE HIRSCHBOECK DUDEK S C, 555 EAST WELLS STREET, SUITE 1900, MILWAUKEE, WI, 53202, US

(73) Assignee: FAR EASTERN TEXTILE LTD., Taipei (TW)

(21) Appl. No.: 11/751,705

(22) Filed: May 22, 2007

(30) Foreign Application Priority Data
May 26, 2006 (TW) 095118765

(51) Int. Cl. G02B 27/00

(52) U.S. Cl. 359/601

(57) ABSTRACT

An anti-glare device includes a transparent anti-glare film incorporating a plurality of water-soluble scattering particles distributed therein. A method for making the anti-glare device includes the steps of: a) mixing a transparent resin solution with an aqueous solution of water-soluble colloid to form an emulsion containing a plurality of water-soluble colloidal particles distributed in the emulsion; b) applying the emulsion on a transparent substrate to form a preliminary film on the substrate; and c) curing the preliminary film to form a transparent anti-glare film on the transparent substrate, the transparent anti-glare film including a plurality of the colloidal particles distributed within the transparent anti-glare film and on a surface of the transparent anti-glare film.

### CROSS-REFERENCE TO RELATED APPLICATION

This application claims priority of Taiwanese application No. 095118765, filed on May 26, 2006.

### BACKGROUND OF THE INVENTION

1. Field of the Invention

The invention relates to an anti-glare device, more particularly to an anti-glare device containing water-soluble scattering particles for improving the clarity of a displaying device. The invention also relates to a method for making the anti-glare device.

2. Description of the Related Art

Conventionally, a displaying device has a mirror-like surface, which will present an uncomfortable glaring effect to the viewer when light emitting from a light source is projected onto the surface in a specific angle and is then reflected from the surface with high brightness. Such a glaring effect will interfere with the information displayed by the displaying device.

In order to reduce the glaring effect, an anti-glare film is adhered or coated onto the surface of the displaying device so as to scatter the ambient light projected on the surface of the displaying device and to reduce the glaring effect.

Conventionally, a transparent resin incorporating a plurality of scattering particles distributed therein is applied on a substrate, such as the surface of the displaying device, to form the anti-glare film on the substrate. The ambient light that reaches the anti-glare film is reflected, refracted and/or scattered by the particles so as to increase the haze value and to reduce the brightness of the light reflected from the film. The scattering particles are conventionally made of an inorganic material, such as silica, zirconia, titania, aluminia, and stannic oxide, or an organic material, such as polystyrene, polymethyl methacrylate, and acrylate-styrene copolymer. The more the scattering particles, the higher the haze value will be. Generally, the haze value of the anti-glare film ranges from 5% to 40%.

However, the light emitting from the displaying device is also refracted and/or scattered by the particles, which in turn reduces the clarity of the displaying device.

### SUMMARY OF THE INVENTION

After various researches and experiments, the Applicants found that the anti-glaring effect of an anti-glare film can be improved while maintaining satisfactory clarity of a surface of a displaying device by using water-soluble scattering particles to substitute for the conventional scattering particles.

Therefore, it is an object of the present invention to provide an anti-glare device which provides the anti-glaring effect while maintaining satisfactory clarity.

It is another object of the present invention to provide a method for making the anti-glare device.

According to a first aspect of this invention, an anti-glare device includes a transparent anti-glare film incorporating a plurality of water-soluble scattering particles distributed therein.

According to a second aspect of this invention, a method for making an anti-glare device includes the steps of:

a) mixing a transparent resin solution with an aqueous solution of water-soluble colloid to form an emulsion containing a plurality of water-soluble colloidal particles distributed in the emulsion;

b) applying the emulsion on a transparent substrate to form a preliminary film on the substrate; and

c) curing the preliminary film to form a transparent anti-glare film on the transparent substrate, the transparent anti-glare film including a plurality of the colloidal particles distributed within the transparent anti-glare film and on a surface of the transparent anti-glare film.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic view of a first preferred embodiment of an anti-glare device according to this invention;

FIG. 2 is a flow diagram of the preferred embodiment of a method for making an anti-glare device according to this invention;

FIG. 3 is a fragmentary schematic view of a second preferred embodiment of an anti-glare device according to this invention;

FIG. 4 is an optical microscopy photograph (200×) of the first preferred embodiment;

FIG. 5 is a scanning electron microscopy photograph of the first preferred embodiment;

FIG. 6 is another scanning electron microscopy photograph of the first preferred embodiment;

FIG. 7 is an optical microscopy photograph (200×) of the second preferred embodiment;

FIG. 8 is a scanning electron microscopy photograph of the second preferred embodiment; and

FIG. 9 is an optical microscopy photograph (200×) of a conventional anti-glare film.

### DETAILED DESCRIPTION OF THE PREFERRED EMBODIMENTS

Before the present invention is described in greater detail, it should be noted that like elements are denoted by the same reference numerals throughout the disclosure.

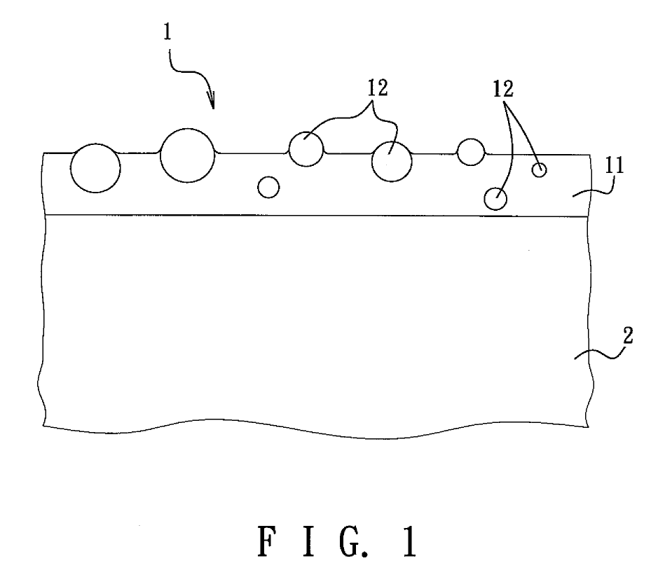

Referring to FIG. 1, there is shown an anti-glare device 1 according to the first preferred embodiment of this invention which includes a transparent anti-glare film 11 and a transparent substrate 2 supporting the transparent anti-glare film 11.

The transparent anti-glare film 11 incorporates a plurality of water-soluble scattering particles 12 distributed therein. Specifically, the water-soluble scattering particles 12 are distributed within the transparent anti-glare film 11 and on a surface of the transparent anti-glare film 11.

The water-soluble scattering particles 12 are preferably colloidal particles made of gelatin, hydrogel, polyvinyl alcohol, or the like.

The transparent anti-glare film 11 is made of an ultraviolet curable resin, a thermoplastic resin, a thermosetting resin, or the like. An example of the ultraviolet curable resin is an acrylate resin. Examples of the thermoplastic resin include an acrylic resin, an acetal resin, or the like. Examples of the thermosetting resin include an epoxy resin, polyurethane, or the like. Preferably, the material for the transparent anti-glare film 11 has an optical transmission of at least 90% and a pencil hardness of at least 3 H. The more the pencil hardness, the better the scratch resistance of the transparent anti-glare film 11 will be.

The transparent substrate 2 is made of a transparent material, such as plastic, glass, or the like. Examples of the plastic material include polyethylene terephthalate, polyethylene-2,6-naphthalate, cellulose triacetate, or the like. Optionally, other films, such as a low reflection film, an antistatic film, or the like, can be applied on the transparent anti-glare film 11 to provide a multi-functional optical film for the anti-glare device 1.

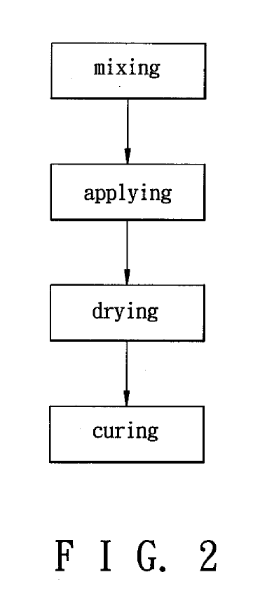

Referring to FIGS. 1 and 2, the preferred embodiment of a method for making the anti-glare device 1 according to this invention includes the steps of:

A) mixing:

A transparent resin solution is mixed with an aqueous solution of water-soluble colloid by stirring with a high speed stirrer to form an emulsion containing a plurality of water-soluble colloidal particles distributed in the emulsion. The aqueous solution of water-soluble colloid may be an aqueous gelatin solution, an aqueous hydrogel solution, or an aqueous polyvinyl alcohol solution. Preferably, the stirring is conducted at a stirring rate ranging from 6000 to 12000 revolutions per minute (rpm) for a period ranging from 30 to 90 minutes.

B) applying:

The emulsion is applied on the transparent substrate 2 to form a preliminary film on the substrate

C) drying:

The preliminary film is baked or is allowed to stand for a period so as to evaporate and remove the solvent in the transparent resin solution and the water in the aqueous solution of water-soluble colloid from the preliminary film.

D) curing:

The preliminary film is cured, for example, by irradiating with an ultraviolet light or by heating to form a transparent anti-glare film 11 on the transparent substrate 2. The transparent anti-glare film 11 includes a plurality of scattering particles 12 formed of the colloidal particles distributed within the transparent anti-glare film 11 and on a surface of the transparent anti-glare film 11.

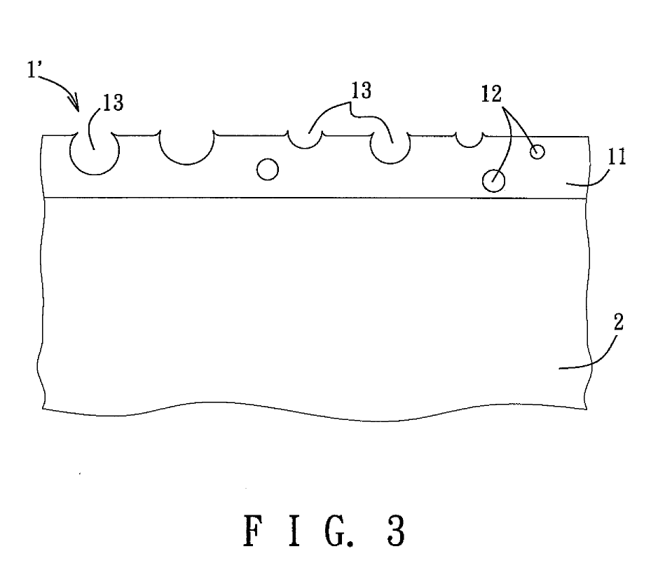

Referring to FIG. 3, there is shown an anti-glare device 1′ according to the second preferred embodiment of this invention which is similar to the anti-glare device 1 of the first preferred embodiment except that the anti-glare film 11 further includes a plurality of indentations 13 distributed on a surface thereof.

The method for making the anti-glare device 1′ is similar to that for making the anti-glare device 1 except that it further includes a step of removing the scattering particles 12 present on the surface of the transparent anti-glare film 11 after the curing step so as to form a plurality of indentations 13 on the surface of the transparent anti-glare film 11. The scattering particles 12 present on the surface of the transparent anti-glare film 11 can be removed by treating the surface of the transparent anti-glare film 11 with water, for example, by spraying the surface of the transparent anti-glare film 11 with water or by dipping the transparent anti-glare film 11 in water. Depending on the scattering particles 12 to be removed, water can be optionally preheated so as to enhance the dissolution of the scattering particles 12 present on the surface of the transparent anti-glare film 11. For example, if the scattering particles 12 are made of gelatin, water can be preheated to a temperature ranging from 50 to 60° C.

The following examples are provided to illustrate the preferred embodiments of the invention, and should not be construed as limiting the scope of the invention.

### EXAMPLES

### Example 1

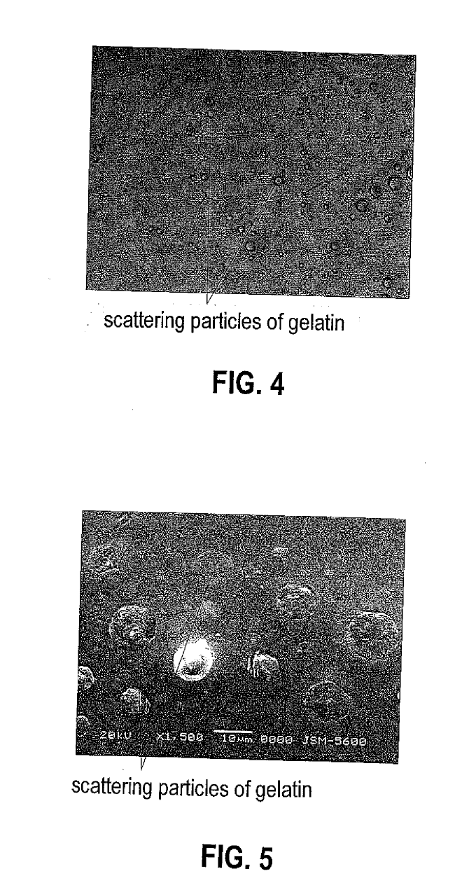

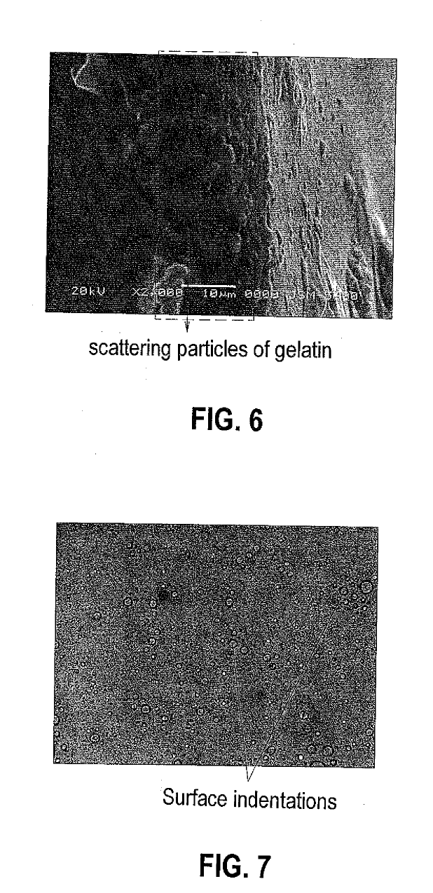

25 parts by weight of gelatin was dissolved in 125 parts by weight of water at 50-60° C. to form a gelatin solution. The gelatin solution was mixed with 200 parts by weight of an acrylate resin solution (5537C-50, manufactured by Eternal Chemical Co. Ltd., Taiwan, and containing 50% of acrylate resin and 50% of toluene) by stirring homogeneously at a stirring rate of 8000 rpm for 60 minutes to form an emulsion. The emulsion was applied on a transparent cellulose triacetate substrate of 80 μm, was dried at 80° C. for 2 minutes to evaporate water and toluene out of the emulsion, and was cured by irradiating with ultraviolet light at 230 mj/cm² to form a 5 μm anti-glare film 11 on the substrate 2, as best shown in FIGS. 1, 4, 5, and 6. The anti-glare film 11 includes a plurality of scattering particles 12 distributed within the transparent anti-glare film 11 and on a surface of the transparent anti-glare film 11. The size of the particles 12 is about 1-10 μm.

### Example 2

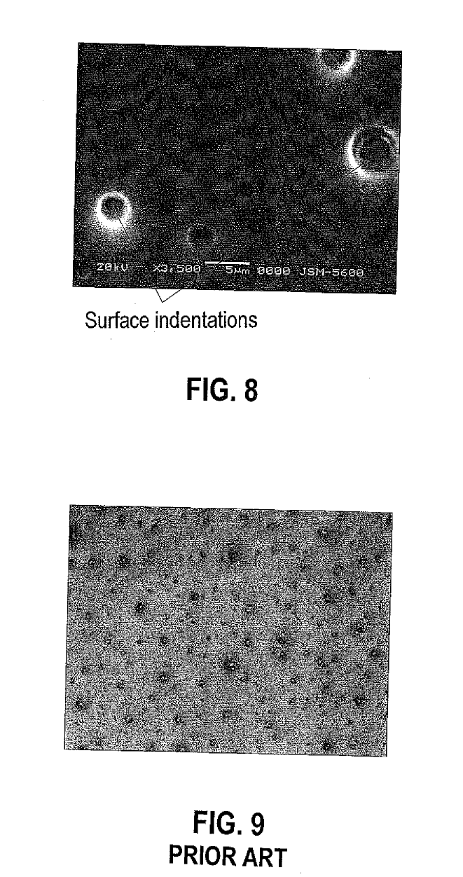

The anti-glare film 11 formed in Example 1 is dipped in water at 50-60° C. for about 2 minutes to remove at least some of the scattering particles 12 on a surface of the transparent anti-glare film 11 so as to form a plurality of indentations 13 on the surface of the transparent anti-glare film 11, as best shown in FIGS. 3, 7, and 8.

### Example 3

The procedure of Example 2 was repeated except that the gelatin solution was formed by dissolving 5 parts by weight of gelatin in 25 parts by weight of water at 50-60° C., and that the transparent cellulose triacetate substrate was replaced with a transparent polyethylene terephthalate substrate.

### Example 4

This example is substantially identical to Example 3 except that the gelatin solution was formed by dissolving 15 parts by weight of gelatin in 25 parts by weight of water at 50-60° C.

### Example 5

This example is substantially identical to Example 4 except that 2 parts by weight of silica particles (OK607, manufactured by Degussa Co., Ltd., a particle size of 2 μm) was added to the acrylate resin solution. The acrylate resin solution containing the silica particles was then stirred with the gelatin solution at a stirring rate of 3000 rpm for a period of 120 minutes to form an emulsion. The emulsion applied on the polyethylene terephthalate substrate was cured by irradiating with ultraviolet light at 250 mj/cm² to form an anti-glare film on the substrate.

### Comparative Example 1

8 parts by weight of silica particles (OK607, manufactured by Degussa Co., Ltd., a particle size of 2 μm) were stirred with 200 parts by weight of an acrylate resin solution (PC-538, manufactured by Pufong Enterprise Co., Ltd., Taiwan, and containing 50% of acrylate resin and 50% of isopropanol) at a stirring rate of 3000 rpm for 120 minutes to form an emulsion. The emulsion was applied on a transparent cellulose triacetate substrate of 80 μm, was dried at 80° C. for 2 minutes, and was cured by irradiating with ultraviolet light at 250 mj/cm² to form a 5 μm anti-glare film on the substrate, as best shown in FIG. 9.

### Comparative Example 2

The procedure of Comparative Example 1 is repeated except that 5 parts by weight of silica particles were used and that the cellulose triacetate substrate was replaced with a transparent polyethylene terephthlate substrate.

### Measurement of Optical Properties of Anti-Glare Film:

The haze value and the clarity of specimens of Examples 1-5 and Comparative Examples 1-2 were measured according to Standard JIS K 7105. The results are shown in Table 1.

The haze value was measured using a turbidity meter, Model No. NDH2000 manufactured by Nippon Denshoku Co., Ltd, Japan. Clarity was measured using a clarity meter, Model No. ICM-1T manufactured by Suga Test Instruments CO. Ltd. It should be noted that the clarity expressed in Table 1 is the sum of the clarity values measured at five different aperture widths (i.e., 0.125 mm, 0.25 mm, 0.5 mm, 1.0 mm, and 2.0 mm).

TABLE 1

| | Gelatin | Silica | | |
|---|---|---|---|---|
| | (parts by | (parts by | Clarity | Haze value |
| | weight) | weight) | (%) | (%) |
| Ex. 1 | 25 | — | 101 | 21.1 |
| Ex. 2 | 25 | — | 98 | 23.3 |
| Ex. 3 | 5 | — | 363 | 7.2 |
| Ex. 4 | 15 | — | 333 | 15.4 |
| Ex. 5 | 15 | 2 | 128 | 14.8 |
| Comp. Ex. 1 | — | 8 | 30 | 20.2 |
| Comp. Ex. 2 | — | 5 | 36 | 13.9 |

On comparing Examples 1 and 2 with Comparative Example 1, when the haze value is about 20%, the clarity of Examples 1 and 2 is significantly higher than that of Comparative Example 1. On comparing Examples 4 and 5 with Comparative Example 2, when the haze value is about 14%, the clarity of Examples 4 and 5 is significantly higher than that of Comparative Example 2. However, since silica particles were incorporated in Example 5, the clarity of Example 5 is lower than that of Example 4. It is thus demonstrated that the clarity of an anti-glare film can be improved by substituting the water-soluble scattering particles for the silica particles and by forming the indentations on the surface of the anti-glare film. Furthermore, in view of the results of Examples 1-4, when the haze value decreases to a lower level as shown in Example 3 and 4, the clarity of the anti-glare film is excellent due to the water-soluble scattering particles and/or the indentations.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An anti-glare device, comprising:
a transparent anti-glare film incorporating a plurality of water-soluble scattering particles distributed therein.

2. The anti-glare device as claimed in claim 1, wherein said anti-glare film further includes a plurality of indentations distributed on a surface thereof.

3. The anti-glare device as claimed in claim 1, wherein said water-soluble scattering particles are colloidal particles.

4. The anti-glare device as claimed in claim 3, wherein said colloidal particles are made of a material selected from the group consisting of gelatin, hydrogel, and polyvinyl alcohol.

5. The anti-glare device as claimed in claim 4, wherein said colloidal particles are made of gelatin.

6. The anti-glare device as claimed in claim 1, wherein said transparent anti-glare film is made of a material selected from the group consisting of an ultraviolet curable resin, a thermoplastic resin, and a thermosetting resin.

7. The anti-glare device as claimed in claim 6, wherein said transparent anti-glare film is made of an ultraviolet curable resin.

8. The anti-glare device as claimed in claim 1, further comprising a transparent substrate supporting said transparent anti-glare film.

9. A method for making an anti-glare device, comprising the steps of:
a) mixing a transparent resin solution with an aqueous solution of water-soluble colloid to form an emulsion containing a plurality of water-soluble colloidal particles distributed in the emulsion;
b) applying the emulsion on a transparent substrate to form a preliminary film on the substrate; and
c) curing the preliminary film to form a transparent anti-glare film on the transparent substrate, the transparent anti-glare film including a plurality of the colloidal particles distributed within the transparent anti-glare film and on a surface of the transparent anti-glare film.

10. The method as claimed in claim 9, further comprising step d) removing the colloidal particles present on the surface of the transparent anti-glare film after the step c) so as to form a plurality of indentations on the surface of the transparent anti-glare film.

11. The method as claimed in claim 10, wherein the step d) is conducted using water to dissolve out the colloidal particles present on the surface of the transparent anti-glare film.

12. The method as claimed in claim 9, wherein the aqueous solution of water-soluble colloid is selected from the group consisting of an aqueous gelatin solution, an aqueous hydrogel solution, and an aqueous polyvinyl alcohol solution.

13. The method as claimed in claim 12, wherein the aqueous solution of water-soluble colloid is an aqueous of gelatin solution.

14. The method as claimed in claim 9, wherein the mixing is done by stirring at a rate ranging from 6000 to 12000 revolutions per minute.

15. The method as claimed in claim 14, wherein stirring is carried out for a period ranging from 30 to 90 minutes.

16. The method as claimed in claim 9, further comprising a step of drying the preliminary film prior to the step c).
